(19) United States
(12) Patent Application Publication
(10) Pub. No.: US 2009/0228232 A1
(43) Pub. Date: Sep. 10, 2009

(54) RANGE-BASED EVALUATION

(76) Inventors: Gary F. Anderson, Danbury, CT (US); Mark S. Ramsey, Kihei, HI (US); David A. Selby, Nr Fareham (GB); Stephen J. Todd, Winchester (GB)

Correspondence Address: HOFFMAN WARNICK LLC, 75 STATE ST, 14TH FLOOR, ALBANY, NY, 12207, US

(21) Appl. No.: 12/043,564

(22) Filed: Mar. 6, 2008

(51) Int. Cl. G06F 15/00

(52) U.S. Cl. 702/127

(57) ABSTRACT

A solution for evaluating an entity includes assigning an attribute score to each of a plurality of attributes of the entity. For one or more of the attributes, the corresponding attribute score is assigned by determining one of a plurality of ranges of values that corresponds to an attribute value of the entity for the attribute and assigning the attribute score based on the determined one of the plurality of ranges. A composite score is generated for the entity based on the attribute scores for the attributes, which can be further processed to, for example, evaluate whether the event is suspicious in real time.

### TECHNICAL FIELD

The disclosure relates generally to evaluating an entity, and more particularly, to evaluating the entity by analyzing one or more of its attributes using ranges of values.

### BACKGROUND ART

Fraud and other exception detection approaches attempt to detect problems by looking at values of particular attributes of particular entities. Typically, many attributes of each entity are tracked, and the approach seeks to identify exceptional behavior based on the tracked attributes. For example, an entity can be a credit card, and various attributes of its use can be tracked. Similarly, the entity can be an employee for which various aspects of his/her behavior are tracked, a health provider for which various aspects of its medical service reimbursement requests are tracked, etc.

In a typical approach, a score is generated for each attribute of each entity based on a corresponding value of the attribute. To date, various approaches use statistical data to define a “normal” range of values for the attribute (e.g., by calculating a mean, mode, and/or standard deviation) and calculate attribute scores based on the value of the attribute and the statistical data. The attribute score is then analyzed with respect to its variance from the normal range of values. Some approaches seek to improve analysis of these calculations by using artificial intelligence approaches, such as fuzzy logic. The individual attribute scores for an entity are then combined to yield an overall composite score for the entity. Entities with the highest composite scores are the most suspicious and may be flagged for follow up analysis. More complicated approaches incorporate mathematical fitting functions, but these approaches can be very expensive to run in terms of the amount of runtime required and/or the required processing resources.

Increasingly, it is desired to perform fraud detection on events generated by the entities in real time. However, current approaches to generating attribute scores do not provide real time evaluations without requiring the use of an unacceptable amount of computing resources. Further, current approaches often do not provide composite scores that can be utilized with sufficient accuracy (e.g., sufficiently low false positives and/or false negatives) for fully automated evaluations.

A histogram is a type of bar graph that represents a frequency distribution. In a histogram, each bar is assigned a corresponding range of values, and a height of the bar is adjusted based on the frequency that data falls within the range of values. Conceptually, or in application, each bar can have a corresponding “bucket” that stores the data values that fall within the corresponding range of values. A height of the bar in the histogram can be set based on the number of data values that are within the bucket.

A “hybrid histogram” has been previously described in order to facilitate analysis of events in real time. For example, a solution incorporating a hybrid histogram in real time data analysis is shown and described in the co-owned, co-pending U.S. patent application Ser. No. 11/609,457, filed on 12 Dec. 2006, and titled “Real time analytics using hybrid histograms”, which is hereby incorporated by reference. The solution utilizes a structure with information similar to that of a histogram, but with varying boundaries between percentile ranges. The percentile ranges are periodically (e.g., from time to time when deemed appropriate) recalculated. The hybrid histogram can be analyzed to identify potentially fraudulent activities, identify trends and patterns, identify risks, identify problems, identify business opportunities, etc. For example, a new data event value that falls into a top percentile range may indicate an unusual bank withdrawal, an unusual amount of bandwidth usage in a network, etc.

### SUMMARY OF THE INVENTION

Aspects of the invention provide a solution for evaluating an entity includes assigning an attribute score to each of a plurality of attributes of the entity. For one or more of the attributes, the corresponding attribute score is assigned by determining one of a plurality of ranges of values that corresponds to an attribute value of the entity for the attribute and assigning the attribute score based on the determined one of the plurality of ranges. A composite score is generated for the entity based on the attribute scores for the attributes, which can be further processed to, for example, evaluate whether the event is suspicious in real time.

A first aspect of the invention provides a method of evaluating an entity, the method comprising: assigning an attribute score to each of a plurality of attributes of the entity, the assigning including, for at least one of the plurality of attributes: determining one of a plurality of ranges of values that corresponds to an attribute value of the entity for the attribute; and assigning the attribute score based on the determined one of the plurality of ranges; generating a composite score for the entity based on the attribute scores for the plurality of attributes; and writing the composite score for the entity to a computer-readable medium for further processing.

A second aspect of the invention provides a system for evaluating an entity, the system comprising: a component for assigning an attribute score to each of a plurality of attributes of the entity, wherein, for at least one of the plurality of attributes, the component for assigning determines one of a plurality of ranges of values that corresponds to an attribute value of the entity for the attribute and assigns the attribute score based on the determined one of the plurality of ranges; and a component for generating a composite score for the entity based on the attribute scores for the plurality of attributes and writing the composite score for the entity to a computer-readable medium for further processing.

A third aspect of the invention provides a computer program comprising program code embodied in at least one computer-readable medium, which when executed, enables a computer system to implement a method of evaluating an entity, the method comprising: assigning an attribute score to each of a plurality of attributes of the entity, the assigning including, for at least one of the plurality of attributes: determining one of a plurality of ranges of values that corresponds to an attribute value of the entity for the attribute; and assigning the attribute score based on the determined one of the plurality of ranges; generating a composite score for the entity based on the attribute scores for the plurality of attributes; and writing the composite score for the entity to a computer-readable medium for further processing.

A fourth aspect of the invention provides a method of generating a system for evaluating an entity, the method comprising: providing a computer system operable to: assign an attribute score to each of a plurality of attributes of the entity, the assigning including, for at least one of the plurality of attributes: determining one of a plurality of ranges of values that corresponds to an attribute value of the entity for the attribute; and assigning the attribute score based on the determined one of the plurality of ranges; generate a composite score for the entity based on the attribute scores for the plurality of attributes; and write the composite score for the entity to a computer-readable medium for further processing.

A fifth aspect of the invention provides a method comprising: at least one of providing or receiving a copy of a computer program that is embodied in a set of data signals, wherein the computer program enables a computer system to implement a method of evaluating an entity, the method comprising: assigning an attribute score to each of a plurality of attributes of the entity, the assigning including, for at least one of the plurality of attributes: determining one of a plurality of ranges of values that corresponds to an attribute value of the entity for the attribute; and assigning the attribute score based on the determined one of the plurality of ranges; generating a composite score for the entity based on the attribute scores for the plurality of attributes; and writing the composite score for the entity to a computer-readable medium for further processing.

Other aspects of the invention provide methods, systems, program products, and methods of using and generating each, which include and/or implement some or all of the actions described herein. The illustrative aspects of the invention are designed to solve one or more of the problems herein described and/or one or more other problems not discussed.

### BRIEF DESCRIPTION OF THE DRAWINGS

These and other features of the disclosure will be more readily understood from the following detailed description of the various aspects of the invention taken in conjunction with the accompanying drawings that depict various aspects of the invention.

FIG. 1 shows an illustrative environment for evaluating events according to an embodiment.

FIG. 2 shows an illustrative process for evaluating events according to an embodiment.

It is noted that the drawings are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

Aspects of the invention expand upon the concept of the hybrid histogram, which was previously shown and described in the co-owned, co-pending U.S. patent application Ser. No. 11/609,457, filed on 12 Dec. 2006, and titled “Real time analytics using hybrid histograms”. As used herein, the phrase “hybrid histogram” is used in the same manner as used in the previously filed patent application, and generally refers to a structure that includes multiple buckets, each having an assigned range of values, and for which the boundaries that define the ranges of values are periodically (e.g., based on any type of criteria) adjusted. The boundaries can be adjusted in a manner that results in each bucket having substantially the same frequency (e.g., number of entries) after the adjustment. As used herein, unless otherwise noted, the term “set” means one or more (i.e., at least one) and the phrase “any solution” means any now known or later developed solution.

As indicated above, aspects of the invention provide a solution for evaluating an entity includes assigning an attribute score to each of a plurality of attributes of the entity. For one or more of the attributes, the corresponding attribute score is assigned by determining one of a plurality of ranges of values that corresponds to an attribute value of the entity for the attribute and assigning the attribute score based on the determined one of the plurality of ranges. A composite score is generated for the entity based on the attribute scores for the attributes, which can be further processed to, for example, evaluate whether the event is suspicious in real time.

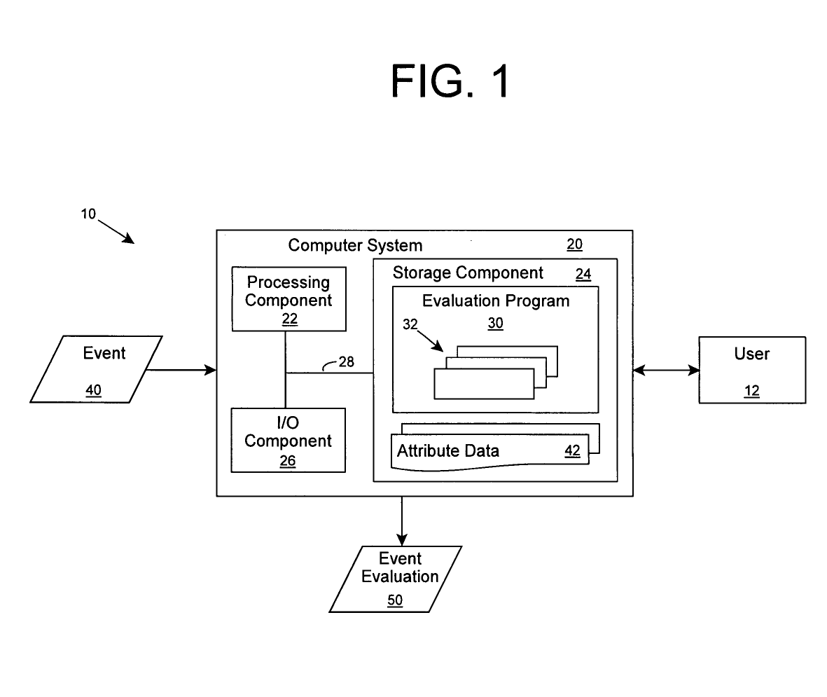

Turning to the drawings, FIG. 1 shows an illustrative environment 10 for evaluating events 40 according to an embodiment. To this extent, environment 10 includes a computer system 20 that can perform a process described herein in order to evaluate events 40. In particular, computer system 20 is shown including an evaluation program 30, which makes computer system 20 operable to evaluate events 40 by performing a process described herein.

Computer system 20 is shown including a processing component 22 (e.g., one or more processors), a storage component 24 (e.g., a storage hierarchy), an input/output (I/O) component 26 (e.g., one or more I/O interfaces and/or devices), and a communications pathway 28. In general, processing component 22 executes program code, such as evaluation program 30, which is at least partially stored in storage component 24. While executing program code, processing component 22 can process data, which can result in reading and/or writing the data to/from storage component 24 and/or I/O component 26 for further processing. Pathway 28 provides a communications link between each of the components in computer system 20. I/O component 26 can comprise one or more human I/O devices, which enable a human user 12 to interact with computer system 20 and/or one or more communications devices to enable a system user 12 to communicate with computer system 20 using any type of communications link. To this extent, evaluation program 30 can manage a set of interfaces (e.g., graphical user interface(s), application program interface, and/or the like) that enable human and/or system users 12 to interact with evaluation program 30. Further, evaluation program 30 can manage (e.g., store, retrieve, create, manipulate, organize, present, etc.) the data, such as attribute data 42, using any solution.

In any event, computer system 20 can comprise one or more general purpose computing articles of manufacture (e.g., computing devices) capable of executing program code installed thereon. As used herein, it is understood that “program code” means any collection of instructions, in any language, code or notation, that cause a computing device having an information processing capability to perform a particular function either directly or after any combination of the following: (a) conversion to another language, code or notation; (b) reproduction in a different material form; and/or (c) decompression. To this extent, evaluation program 30 can be embodied as any combination of system software and/or application software.

Further, evaluation program 30 can be implemented using a set of modules 32. In this case, a module 32 can enable computer system 20 to perform a set of tasks used by evaluation program 30, and can be separately developed and/or implemented apart from other portions of evaluation program 30. As used herein, the terms component and module mean any configuration of hardware, with or without software, which implements and/or enables a computer system 20 to implement the functionality described in conjunction therewith using any solution. Regardless, it is understood that two or more components, modules, and/or systems may share some/all of their respective hardware and/or software. Further, it is understood that some of the functionality discussed herein may not be implemented or additional functionality may be included as part of computer system 20.

When computer system 20 comprises multiple computing devices, each computing device can have only a portion of evaluation program 30 installed thereon (e.g., one or more modules 32). However, it is understood that computer system 20 and evaluation program 30 are only representative of various possible equivalent computer systems that may perform a process described herein. To this extent, in other embodiments, the functionality provided by computer system 20 and evaluation program 30 can be at least partially implemented by one or more computing devices that include any combination of general and/or specific purpose hardware with or without program code. In each embodiment, the hardware and program code, if included, can be created using standard engineering and programming techniques, respectively.

Regardless, when computer system 20 includes multiple computing devices, the computing devices can communicate over any type of communications link. Further, while performing a process described herein, computer system 20 can communicate with one or more other computer systems using any type of communications link. In either case, the communications link can comprise any combination of various types of wired and/or wireless links; comprise any combination of one or more types of networks; and/or utilize any combination of various types of transmission techniques and protocols.

As discussed herein, evaluation program 30 enables computer system 20 to evaluate events 40, e.g., in real time. Each event 40 includes information on a plurality of attributes of the event, which can be stored and structured using any solution. For each attribute, event 40 can store a value that corresponds to the attribute. For example, an illustrative event 40 can comprise a credit card transaction, and the information can comprise data on the transaction, such as a vendor, an amount, a location, a time, etc. Similarly, an illustrative event can comprise a medical practice reimbursement claim, and the information can comprise data on the reimbursement claim, such as a medical practice, an amount, a practice area for the claim, etc. It is understood that these events are only illustrative, and numerous types of events are possible under various possible implementations of an embodiment of the invention. Further, while the invention is shown and described as evaluating events, it is understood that embodiments of the invention can be implemented to evaluate any type of entity (e.g., any physical or conceptual object, such as a person, a group of related items, and/or the like) about which information is stored.

In order to evaluate one or more attributes for each event 40, computer system 20 can manage attribute data 42 for the attribute(s) using any solution. In an illustrative application, computer system 20 manages a data structure for storing and retrieving attribute data 42, which defines: a range of values for each bucket (e.g., by storing the boundary value between each pair of adjacent buckets), a count of entries in each bucket, and/or the like. Attribute data 42 can include any number of buckets. In an illustrative embodiment, attribute data 42 includes a number of buckets that is a power of two, such as thirty-two or sixty-four, and computer system 20 uses a binary search algorithm to identify a bucket for a particular value.

As computer system 20 processes event 40, the attribute data 42 is utilized and updated accordingly. In particular, for a particular attribute of event 40, computer system 20 will determine a corresponding bucket in which the attribute belongs based on its value, update a count of the entries in the bucket, and generate an attribute score for the attribute of event 40 based on the bucket. Computer system 20 can periodically recalculate the data ranges (e.g., boundary values) for the buckets and corresponding entries in each bucket using any solution. For example, computer system 20 can recalculate the data ranges every N (e.g., 100) events 40, when a bucket is determined to be unbalanced (e.g., have too high a percentage of the entries), and/or the like. In an embodiment, computer system 20 implements the boundary rebalancing algorithm shown and described in the co-owned, co-pending U.S. patent application Ser. No. 11/609,457, filed on 12 Dec. 2006, and titled “Real time analytics using hybrid histograms”. However, computer system 20 can utilize any solution for recalculating the data ranges.

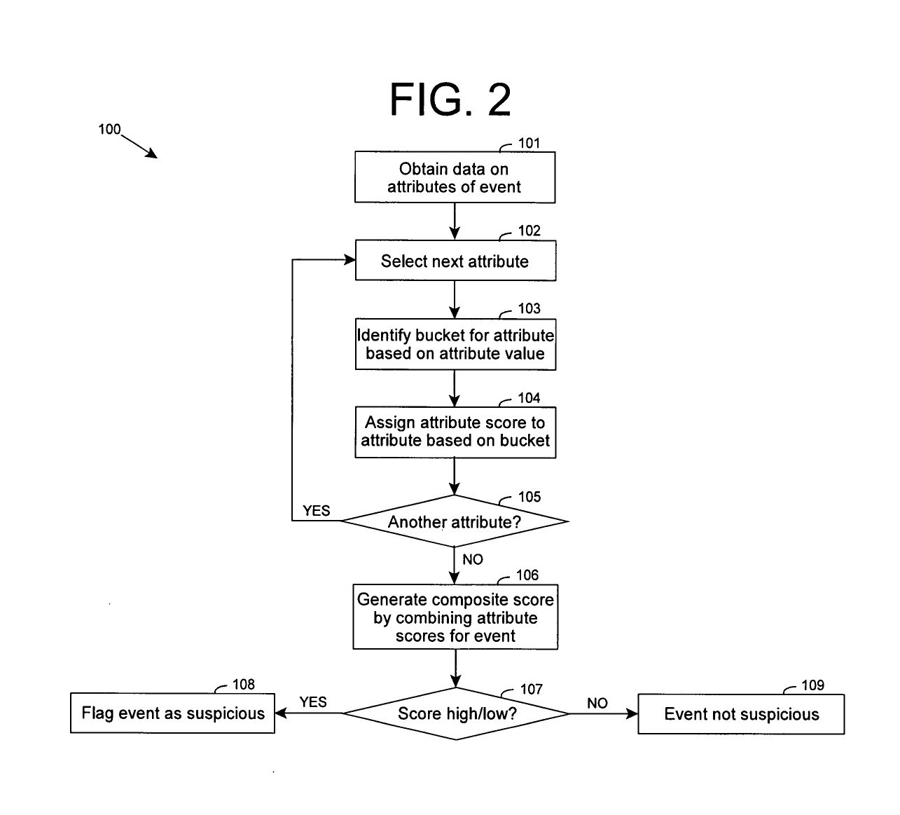

FIG. 2 shows an illustrative process 100 for evaluating events, which can be implemented by computer system 20 (FIG. 1), according to an embodiment. Referring to FIGS. 1 and 2, in process 101, computer system 20 can obtain event 40, which includes data on various attributes of an event, using any solution. For example, computer system 20 can generate and/or be used to generate events 40, retrieve events 40 from one or more data stores, receive events 40 from another system (e.g., user 12), and/or the like. Regardless, once an event 40 is obtained for processing, computer system 20 can extract the data (e.g., attribute value) for each attribute of event 40 using any solution. In an illustrative application, event 40 may include data on forty or more different attributes. It is understood that event 40 may not expressly include data for every attribute of event 40. In this case, computer system 20 can use default data (e.g., a default value) for the attribute, not process the attribute, and/or the like.

In processes 102-105, computer system 20 can sequentially process each attribute of event 40 to assign an attribute score for each attribute of each entity. However, it is understood that this is only illustrative of various processes that computer system 20 can implement to assign the attribute scores. To this extent, in other embodiments, computer system 20 can assign the attribute scores in parallel and/or using any alternative process that will result in each event 40 being evaluated having a range-based attribute score assigned to each attribute thereof. Additionally, while each attribute is shown and described as having a range-based attribute score, it is understood that computer system 20 can calculate the attribute scores for one or more attributes using any solution, such as a non-range-based solution.

In any event, in process 102, computer system 20 can select a next attribute of event 40 for processing. In process 103, computer system 20 can identify a bucket (range of values) in attribute data 42 for the attribute based on an attribute value of event 40 using any solution. For example, computer system 20 can perform a binary search on the boundary values for the buckets to identify the bucket having a range of values that corresponds to the attribute value of event 40. Once identified, computer system 20 can increment a count of the entries in the bucket, which computer system 20 can use when recalculating the data ranges of the buckets as discussed herein.

In process 104, computer system 20 can assign an attribute score to the attribute of event 40 based on the identified bucket using any solution. For example, each bucket can be assigned a corresponding value that computer system 20 uses as the attribute score. Computer system 20 can assign the values to each bucket using any solution, e.g., by: incrementing from the bucket with smallest data range to the bucket with largest data range, or vice versa; incrementing from the outer buckets to the inner buckets (e.g., lowest bucket=1, highest bucket=2, second lowest=3, second highest=4, etc.); assigning a probability to each bucket; assigning a logarithmic value to each bucket; and/or the like. Further, computer system 20 can utilize the data range for each bucket in assigning the attribute value to the bucket. For example, computer system 20 can apply a smoothing formula to a bucket location (e.g., sequential number of the bucket) based on the high and/or low boundary for the bucket. In an embodiment, computer system 20 can implement one or more of the attribute score calculation algorithms shown and described in the co-owned, co-pending U.S. patent application Ser. No. ______, filed on ______, titled “Rank-Based Evaluation”, and identified by Attorney Docket No. END920070342US1, which is hereby incorporated by reference.

In any event, in decision 105, computer system 20 can determine whether attribute scores need to be assigned for another attribute of event 40. If so, flow can return to process 102. If not, in process 106, computer system 20 can generate a composite score for event 40 based on the corresponding attribute scores for the plurality of attributes. For example, computer system 20 can combine the attribute scores using any solution, to yield the composite score. In an embodiment, computer system 20 can multiply the attribute scores for each of the plurality of attributes (e.g., when the attribute scores are based on probabilities). Similarly, computer system 20 can add the attribute scores for each of the plurality of attributes (e.g., when the attribute scores are logarithmic). Still further, computer system 20 can compute an average of the attribute scores (e.g., when they have all been scaled). Still further, once the attribute scores have been combined, computer system 20 can perform further processing, such as scaling the values to a predetermined range, to generate the composite score using any solution.

It is understood that computer system 20 can implement any appropriate solution for generating the composite scores, which can be selected based on the nature of event 40, the method(s) used to calculate the attribute scores, an application for the composite scores, and/or the like. For example, computer system 20 can apply a weight to one or more attribute scores, which may be more or less important than other attribute scores in an overall analysis of the event 40. Further, when two or more attributes are known to have a dependency relationship, computer system 20 can merge the attribute scores for the two or more attributes into a single attribute score, which is used to generate the composite score, using any solution. For example, computer system 20 can use a minimum attribute score, a maximum attribute score, an average attribute score, a statistical calculation (e.g., Bayesian), and/or the like, as the merged attribute score for two or more interdependent attributes. If desired, computer system 20 can apply a weight to the merged score when generating the composite score using any solution.

Computer system 20 can store the composite score for event 40 for further processing and/or analysis by, for example, user 12. Alternatively, computer system 20 can perform further processing/analysis of the composite score to yield a preliminary or final event evaluation 50 of event 40. In process 107, computer system 20 can evaluate whether event 40 is suspicious by, for example, determining if the composite score is outside of an anticipated range (e.g., too low or too high). If so, then in process 108 computer system 20 can flag event 40 as suspicious in event evaluation 50. If not, then in process 109, computer system 20 can indicate that the event is not suspicious in event evaluation 50. In either case, computer system 20 can store and/or provide event evaluation 50 for further processing and/or analysis by, for example, user 12 using any solution (e.g., by communicating, displaying, and/or the like). User 12 can use event evaluation 50 in real time, e.g., to approve/disapprove the event (e.g., credit card transaction, reimbursement request, and/or the like).

While shown and described herein as a method and system for evaluating events 40, it is understood that aspects of the invention further provide various alternative embodiments. For example, in one embodiment, the invention provides a computer program embodied in at least one computer-readable medium, which when executed, enables a computer system to evaluate an event 40. To this extent, the computer-readable medium includes program code, such as evaluation program 30 (FIG. 1), which implements some or all of a process described herein. It is understood that the term “computer-readable medium” comprises one or more of any type of tangible medium of expression capable of embodying a copy of the program code (e.g., a physical embodiment). For example, the computer-readable medium can comprise: one or more portable storage articles of manufacture; one or more memory/storage components of a computing device; a modulated data signal having one or more of its characteristics set and/or changed in such a manner as to encode information in the signal; paper; and/or the like.

In another embodiment, the invention provides a method of providing a copy of program code, such as evaluation program 30 (FIG. 1), which implements some or all of a process described herein. In this case, a computer system can generate and transmit, for reception at a second, distinct location, a set of data signals that has one or more of its characteristics set and/or changed in such a manner as to encode a copy of the program code in the set of data signals. Similarly, an embodiment of the invention provides a method of acquiring a copy of program code that implements some or all of a process described herein, which includes a computer system receiving the set of data signals described herein, and translating the set of data signals into a copy of the computer program embodied in at least one computer-readable medium. In either case, the set of data signals can be transmitted/received using any type of communications link.

In still another embodiment, the invention provides a method of generating a system for evaluating events 40. In this case, a computer system, such as computer system 20 (FIG. 1), can be obtained (e.g., created, maintained, made available, etc.) and one or more modules for performing a process described herein can be obtained (e.g., created, purchased, used, modified, etc.) and deployed to the computer system. To this extent, the deployment can comprise one or more of: (1) installing program code on a computing device from a computer-readable medium; (2) adding one or more computing and/or I/O devices to the computer system; and (3) incorporating and/or modifying the computer system to enable it to perform a process described herein.

It is understood that aspects of the invention can be implemented as part of a business method that performs a process described herein on a subscription, advertising, and/or fee basis. That is, a service provider could offer to evaluate events 40 as described herein. In this case, the service provider can manage (e.g., create, maintain, support, etc.) a computer system, such as computer system 20 (FIG. 1), that performs a process described herein for one or more customers. In return, the service provider can receive payment from the customer(s) under a subscription and/or fee agreement, receive payment from the sale of advertising to one or more third parties, and/or the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

What is claimed is:

1. A method of evaluating an entity, the method comprising:
assigning an attribute score to each of a plurality of attributes of the entity, the assigning including, for at least one of the plurality of attributes:
determining one of a plurality of ranges of values that corresponds to an attribute value of the entity for the attribute; and
assigning the attribute score based on the determined one of the plurality of ranges;
generating a composite score for the entity based on the attribute scores for the plurality of attributes; and
writing the composite score for the entity to a computer-readable medium for further processing.

2. The method of claim 1, wherein the entity comprises an event.

3. The method of claim 2, further comprising:
receiving the event;
evaluating whether the event is suspicious based on the composite score; and
providing a result of the evaluating for use in real time.

4. The method of claim 1, the generating including merging the attribute scores of at least two attributes into a single attribute score based on a dependency relationship between the at least two attributes.

5. The method of claim 1, further comprising evaluating whether the entity is suspicious based on the composite score.

6. The method of claim 1, further comprising managing a data structure that includes a plurality of boundary values, each boundary value defining a boundary between a pair of adjacent ranges of values, and a count of entries for each range of values for the at least one attribute.

7. The method of claim 6, further comprising periodically recalculating the plurality of boundary values for the at least one attribute.

8. The method of claim 6, the managing including updating the count of entries for the range of values that corresponds to the attribute value.

9. A system for evaluating an entity, the system comprising:
a component for assigning an attribute score to each of a plurality of attributes of the entity, wherein, for at least one of the plurality of attributes, the component for assigning determines one of a plurality of ranges of values that corresponds to an attribute value of the entity for the attribute and assigns the attribute score based on the determined one of the plurality of ranges; and
a component for generating a composite score for the entity based on the attribute scores for the plurality of attributes and writing the composite score for the entity to a computer-readable medium for further processing.

10. The system of claim 9, wherein the entity comprises an event, the system further comprising:
a component for receiving the event;
a component for evaluating whether the event is suspicious based on the composite score; and
a component for providing a result of the evaluating for use in real time.

11. The system of claim 9, wherein the component for generating merges the attribute scores of at least two attributes into a single attribute score based on a dependency relationship between the at least two attributes.

12. The system of claim 9, further comprising a component for evaluating whether the entity is suspicious based on the composite score.

13. The system of claim 9, further comprising a component for managing a data structure that includes a plurality of boundary values, each boundary value defining a boundary between a pair of adjacent ranges of values, and a count of entries for each range of values for the at least one attribute.

14. A computer program comprising program code embodied in at least one computer-readable medium, which when executed, enables a computer system to implement a method of evaluating an entity, the method comprising:
assigning an attribute score to each of a plurality of attributes of the entity, the assigning including, for at least one of the plurality of attributes:
determining one of a plurality of ranges of values that corresponds to an attribute value of the entity for the attribute; and
assigning the attribute score based on the determined one of the plurality of ranges;
generating a composite score for the entity based on the attribute scores for the plurality of attributes; and
writing the composite score for the entity to a computer-readable medium for further processing.

15. The computer program of claim 14, wherein the entity comprises an event, the method further comprising:
receiving the event;
evaluating whether the event is suspicious based on the composite score; and
providing a result of the evaluating for use in real time.

16. The computer program of claim 14, the generating including merging the attribute scores of at least two attributes into a single attribute score based on a dependency relationship between the at least two attributes.

17. The computer program of claim 14, the method further comprising evaluating whether the entity is suspicious based on the composite score.

18. The computer program of claim 14, the method further comprising managing a data structure that includes a plurality of boundary values, each boundary value defining a boundary between a pair of adjacent ranges of values, and a count of entries for each range of values for the at least one attribute.

19. The computer program of claim 18, the method further comprising periodically recalculating the plurality of boundary values for the at least one attribute.

20. A method of generating a system for evaluating an entity, the method comprising:
providing a computer system operable to:
assign an attribute score to each of a plurality of attributes of the entity, the assigning including, for at least one of the plurality of attributes:
determining one of a plurality of ranges of values that corresponds to an attribute value of the entity for the attribute; and
assigning the attribute score based on the determined one of the plurality of ranges;
generate a composite score for the entity based on the attribute scores for the plurality of attributes; and
write the composite score for the entity to a computer-readable medium for further processing.
